(19) United States
(12) Patent Application Publication
(10) Pub. No.: US 2018/0027835 A1
(43) Pub. Date: Feb. 1, 2018

(54) METHOD AND SYSTEM FOR PRODUCING PANELA CHEESE, RESULTING AS BY-PRODUCT WHEY WITHOUT SALT OR WITH MINIMAL AMOUNT OF SALT

(71) Applicant: SIGMA ALIMENTOS, S.A. DE C.V, San Pedro Garza García (MX)

(72) Inventors: Daniel David CHAVEZ VALDEZ, San Nicolas de los Garza (MX); Francisco Miguel MENDOZA CANTU, Monterrey (MX); Gregorio Jose DE HAENE ROSIQUE, Monterrey Nuevo León (MX)

(21) Appl. No.: 15/660,173

(22) Filed: Jul. 26, 2017

Related U.S. Application Data
(60) Provisional application No. 62/366,785, filed on Jul. 26, 2016.

(51) Int. Cl. A23C 19/05; A23C 19/08; A23J 3/08; A23C 19/032

(52) U.S. Cl. CPC A23C 19/05; A23C 19/032; A23C 19/08; A23J 3/08; A23C 19/00

(57) ABSTRACT

A method and system for producing panela cheese resulting as by-product whey without salt or with minimal amount of salt, the method includes processing milk to produce a mixture of cheese curds and whey, wherein optionally the mixture is salted by incorporating a fraction of a total amount of salt required for the manufacture of the panela cheese concerned; extruding, forming and pressing the cheese curds to form cheese blocks and/or simultaneously draining the whey from the cheese curds; optionally subjecting the obtained cheese blocks to a cooling process or a fast cooling process; and promoting absorption of salt by injecting brine to the cheese blocks, wherein the amount of salt absorbed by the cheese block from the brine represents the complement of the total amount of salt required for the manufacture of the panela cheese concerned. The system includes a vat, a cheeseformer apparatus, and a brine injector.

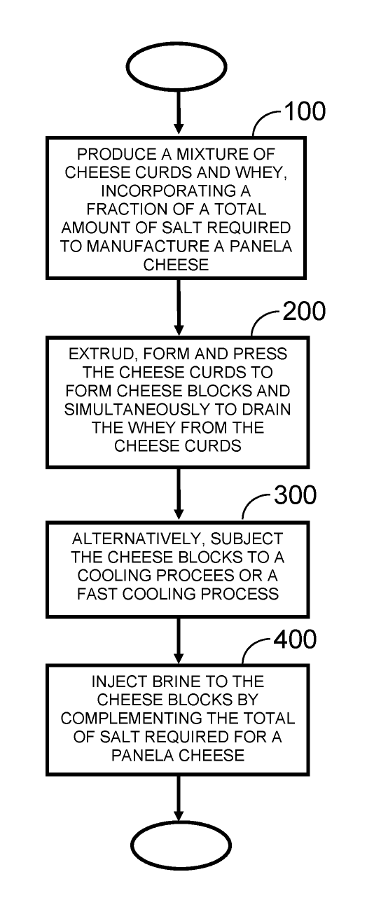

### CROSS-REFERENCE TO RELATED APPLICATIONS

This application claims priority of U.S. Provisional Application No. 62/366,785 filed on Jul. 26, 2016 under 35 U.S.C. §119(e), the entire contents of which are hereby incorporated by reference.

### TECHNICAL FIELD OF THE INVENTION

The present application generally relates to cheese, and more specifically to a method and system for producing panela cheese resulting as by-product whey without salt or with minimal amount of salt.

### BACKGROUND OF THE INVENTION

The panela cheese is a white, fresh and smooth Mexican cheese, also called “panela type”, “panela style” or “canastita panela”, belongs to the category of fresh cheeses (because it is not subjected to any process of maturation). The panela cheese typically it's made with pasteurized whole milk supplemented with calcium chloride and contains from 53 to 58% by weight of moisture, from 18 to 20% by weight of protein, from 19 to 25% by weight of fat, from 1.3 to 1.8% by weight of salt, and a pH from 5.6 to 6.4, however significant variation is observed in the moisture content (52 to 60% by weight) and salt content (1.2 to 2.4% by weight) of panela cheeses founded in the market (See Guisa, F. L. 1999. Types of Mexican cheese: Exploring cheese of Mexico and Latin America. Artisan course. Wisconsin University, Madison, USA; Ramírez-López C, et al. 2012, Quesos Frescos: propiedades, métodos de determinación y factores que afectan su calidad, Universidad de las Américas Puebla; and Path, J. 1991. Hispanic cheese: A promising new market for the specialty cheesemaker. UW Dairy Pipeline. 3(4):1-4; and Briselda García Islas 2006, tesis: Caracterización Físico-quimica de diversos tipos de quesos elaborados en el Valle de Tulancingo Hgo con el fin de proponer normas de calidad).

Salt is a common ingredient in the panela cheese. The amount in the finished panela cheese varies from 1.2% to 2.4% by weight. Salt serves several important functions in panela cheese, including flavor development and control, texture development, control of microbial growth, and optimization of the keeping quality of cheese. Approximately 35 to 50% of the salt added during cheese making is retained in the curd. The rest is expelled via salt whey, which contains 6% or more salt.

The current panela cheese making process generally starts with whole pasteurized milk. The milk is supplemented with calcium chloride and warmed in vats and a lactic acid forming bacteria is added. The cheese maker tracks the progress of the batch by checking the acidity which is read as pH. At the correct time an enzyme called rennet is added which causes the protein to form a curd and whey. The curd is then cut into cubes and the mixture is stirred slowly to collect as much protein as possible into the curd. Then it is salted by spreading and mixing salt grains on the curds and whey mix, the cheese yield is approximately 10% with the remaining 90% a liquid by-product called “salt whey”. The salt whey is drained and conducted through pipes to a storage tank. After, several molds are filled with drained curd and the filled molds are then cooled to form block of fresh cheese. Finally, the blocks of panela cheese are de-molded from the molds.

Salt as a waste product is a potentially toxic substance because of its high chloride content. Environmental regulations therefore limit disposal of such products. Salt whey is a problem for the cheese industry because it cannot readily be discarded, and no applications have been developed that can effectively convert the waste to a useful product. The retention of salt in curd during dry salting is influenced by salting rate, curd temperature, moisture content, pH and size of curd at salting, and extent of mixing of salt and curd during salting as well as other factors. While the cheese maker can readily adjust one or more of these factors to increase the retention of salt in curd and therefore reduce the losses of salt as waste, the production of salt whey cannot be prevented. Brine salting instead of dry salting does not alleviate the problems caused by salt-containing waste products because of the need for large brining tanks and handling of spent brine.

Common disposal practices for salt whey are presently used. However, the emergence of stricter environmental guidelines makes this method of disposal undesirable. Such a practice can cause crop damage because of the high chloride content of salt whey. Treatment of large volumes of salt whey in municipal wastewater plants may also cause chloride overload.

Therefore, the prior art continues to present the problems as described above, so there is still a need to provide a method for producing panela cheese resulting as by-product whey without salt or with minimal amount of salt.

### SUMMARY OF THE INVENTION

In view of the above mentioned and the purpose of providing solutions to the constraints encountered, it is the object of the invention to provide a method for producing panela cheese, resulting as by-product whey without salt or with minimal amount of salt, the method includes: processing milk to produce a mixture of cheese curds and whey, wherein optionally the mixture is salted by incorporating a fraction of a total amount of salt required for the manufacture of the panela cheese concerned; extruding, forming and pressing the cheese curds to form cheese blocks and simultaneously draining the whey from the cheese curds; optionally subjecting the obtained cheese blocks to a cooling process or a fast cooling process; and promoting absorption of salt by injecting brine to the cheese blocks, wherein the amount of salt absorbed by the cheese block from the brine represents the complement of the total amount of salt required for the manufacture of the panela cheese concerned.

Another object of the invention is to provide a system for producing panela cheese resulting as by-product whey without salt or with minimal amount of salt, the system includes a vat for processing milk to produce a mixture of cheese curds and whey, wherein optionally the mixture is salted by incorporating a fraction of a total amount of salt required for the manufacture of the panela cheese concerned; a cheeseformer apparatus for extruding, forming and pressing the cheese curds to form cheese blocks and simultaneously draining the whey from the cheese curds; and a brine injector for promoting absorption of salt by injecting brine to the cheese blocks, wherein the amount of salt absorbed by the cheese block from the brine represents the complement of the total amount of salt required for the manufacture of the panela cheese concerned.

### BRIEF DESCRIPTION OF THE FIGURES

Other features of the present invention will become apparent from the following detailed description considered in connection with the accompanying drawings. It should be understood, however, that the drawings are made only as an illustration and not as a limitative definition of the invention, in which:

The sole FIGURE shows a block diagram of the steps of a method for producing panela cheese resulting as by-product whey without salt or with minimal amount of salt according to the present invention.

### DETAILED DESCRIPTION OF THE INVENTION

The invention refers to a method that allows producing a panela cheese resulting as by product whey without salt or with minimal amount of salt.

In summary, but not limiting the method for producing panela cheese resulting as by-product whey without salt or with minimal amount of salt of the present invention, the invention is shown schematically by the block diagram of the FIGURE which indicates the stages of the method by different numbers and which are described below:

The method starts in step 100 with processing milk supplemented with calcium chloride to produce a mixture of cheese curds and whey in a vat, optionally the mixture is salted by adding from 0% to 6% by weight of salt, this amount of salt representing a fraction of the total amount of salt required for the manufacture of the panela cheese concerned.

After, in step 200, the cheese curds are passing to a cheeseformer apparatus, how the described in the Poland patent PL-395790, this cheeseformer apparatus permits to extrude, form and press the cheese curds to form cheese blocks and simultaneously draining the whey from the cheese curds. The cheeseformer apparatus eliminates the necessity of using the molds for cheese blocks. Under the context of the present invention, the term “cheese block” means a piece of cheese of any form and weighing from 0.2 a 4 kg.

Main part of cheeseformer is a vertical column, cross section of which defines the shape of panela cheese. Lower part of column contains the module for cutting off the pressed panela cheese and a cup with a latch. When latch is open, pressed panela cheese falls down onto conveyor belt.

Above the column is located a hopper and above it there is a preliminary whey drainer. Panela cheese curd is pumped onto whey drainer, where whey is separated from curd by gravity. Curd falls down into hopper, from where it is being equally distributed into molding pipes. Hopper is perforated; therefor some whey is also drained from that part. About 40 to 70% of whey is drained inside whey drainer and hopper. The rest of whey is drained in other elements of molding column. Alternatively, the hopper is equipped with salt dosing device.

Molding pipes are divided into two sections: top—responsible for mechanical whey draining and preliminary molding of panela cheese curd; and bottom—responsible for whey draining by means of vacuum in bottom part of column, and for final molding of panela cheese.

In bottom part of molding unit, under the molding pipes, is located a cutting module. Dosing of curd is made by dosing unit, which are able to adjust the height of panela cheese. Each stamp of dosing unit can be adjusted; therefor height of panela cheese portion from each pipe can be adjusted separately.

Before the knife unit opens, the cups go under the pipes. Portions of panela cheese fall into cups, the knife cuts it off, dosing unit pushes the panela cheese to the surface of knife for final whey pressing and final molding. Then cups with panela cheese moves towards the bottom openings of the unit, latch opens and panela cheese blocks fall down onto belt conveyor.

On top of pressing-molding column there is control equipment, working with a curd pump. The pump should secure the constant level of curd inside the column.

Alternatively, in step 300, the panela cheese blocks are subjecting to a cooling process or a fast cooling process in a cooler.

After, in step 400, the conveyor takes the panela cheese block to a salting process, that promotes the absorption of salt by injecting brine to the panela cheese blocks, the amount of salt absorbed by the panela cheese block from the brine represents the complement of the total amount of salt required for the manufacture of the panela cheese concerned.

A process for injecting brine into cheese is known from Russian patent SU-A-884635. This patent relates to a device for carrying out such a process, and does not specify the diameter of the opening of the nozzles and emphasizes the transport system for the brine. The usefulness of the installation probably lies in production increase by acceleration of the treatment with brine and improved dosage. Although said patent has been published already on Nov. 30, 1981, the applicant is not aware of any practical application thereof.

The lack of any mention regarding a practical application of the above described system or of a further development thereof cannot be explained otherwise than that this system was not satisfactory. After all the possibility to carry out the treatment of a cheese with brine by injection would mean an enormous progress in the production process. Under the context of the present invention, the term “injection” means carrying flow (introduce brine and immediately drain) brine into the cheese until efficient salt has penetrated the cheese mass by salt diffusion. According to the present technology a cheese is salted by immersion in a brine bath or by carrying brine to flow over or around the cheese until efficient salt has penetrated the cheese mass by diffusion. This takes a few days and the brine section occupies a considerable space in the cheese factory. Already because of the factors time and space the possibility to carry out the treatment with brine by injection would be technically and economically extremely attractive. In addition, diffusion is a process which is determined by a large number of factors, such as the temperature, the concentration of the brine, the permeability of the cheese mass, the shape of the cheese, the nature of the surface, etc., so that the obtained salt content of the cheese may rather vary. Furthermore, in the present salting practice the cheese yields water to the brine which is caused by osmotic effects, so that the strength of the brine has to be readjusted regularly. From a point of view of the environment it is undesirable that brine is regularly discarded into the sewer; when the brine is injected, the superfluous brine is collected and recirculated. When the brine is used for a long period of time, the brine becomes contaminated with whey and other organic ingredients. Consequently, growth of undesired micro-organisms can occur. To avoid this the brine is regularly cool down and filtered to eliminate any contaminant. Consequently

Indeed, injection of brine into the cheese is not feasible by usual apparatus. In the meat industry the brine injector is known, which is used e.g. for salting hams. This apparatus injects brine via a large number of needles which are driven into the meat. Such an apparatus is unsuitable for injecting brine into cheese, because at the moment the cheese is to be salted it is in fact still nothing else but a pressed curd and only the salting turns this material into cheese. Also the injection of brine under pressure through nozzles, a principle with is not only known from said Russian patent but is also used in the meat industry, e.g. for salting chicken breast, is not satisfactory without special precautions. After all, current technology apparatus creates unavoidably holes in the cheese rind and when these holes subsequently do not close or do not sufficiently close, an undesirable mold growth can occur and in general the cheese then may obtain an undesirable appearance.

It was found that injecting brine by means of a high-pressure nozzle is possible when a number of requirements are complied with, and furthermore it appeared that this system can then also be used for other treating liquids than brine.

Thus this invention provides a process of the kind mentioned in the first paragraph, which process is characterized in that nozzles having a diameter of the outlet (also named opening) of not more than 2.5 mm are used, said nozzles spraying the treating liquid in a convergent jet.

In contrast the commercially available devices for injecting brine into chicken breast and the like, provide a movement of the material to be salted with respect to the nozzles. It has appeared that when the cheese moves with respect to the nozzles (or the nozzles move with respect to the cheese), the resulting small openings are stretched to cuts, whereby a closing problem is created.

A practical range for the operating pressure is about 0.1 to 2 bar; preferably the pressure is in the range of 0.4 to 1 bar.

The penetration depth is dependent on the operating pressure and the position of the nozzles. The position of the nozzles is variable in the present process; the nozzles can also be pressed against the cheese. The desired penetration depth is dependent on the injected medium.

Of course the injection will be performed at a number of points simultaneously in order to ensure a good distribution of the brine in the cheese as quickly as possible and also in order to avoid spraying a too concentrated brine and/or a too large volume per nozzle. Preferably the nozzles are arranged in a regular pattern with respect to each other, suitably one nozzle per square centimeter of cheese surface, and all□nozzles are simultaneously pressed against the cheese surface where after the brine injection takes place. However, it is also possible to use a more restricted number of nozzles and to move either the cheese or the nozzles a number of times, so that a regular pattern of injection points comes into being, however provided the nozzles and the cheese do not move with respect to each other during the injection.

The amount of brine per injection and the injection pressure determine the depth to which the brine penetrates into the cheese. Dependent on the shape and the firmness of the cheese, the most favorable conditions can be selected under which a sufficiently deep injection of the brine is achieved; so that thereafter a further distribution of the salt throughout the whole cheese by diffusion becomes possible.

After forming, extruding or filling in molds the curd particles start to fuse to a homogeneous mass, whereby the firmness of the cheese increases. For the injection it is of importance that the curd is optimally fused.

Because the penetrating jet of brine still causes some deformation of the cheese surface, it can be useful sometimes to press in mold, heat and/or vacuum packing the cheese again after the injection, which also promotes the closing of the surface.

A further important advantage is that for the traditional method of salting not only brine baths were necessary for ordinary kinds of cheese, but in addition separate baths with dietary salt solutions for dietary cheeses, while when using the present process this is no longer necessary and a fresh solution of ordinary salt or dietary salt can be prepared per production.

The strength of the brine, the brine flowing time inside cheese, the brine volume dosed per injection and the number of injections per cheese determine the amount of salt in the cheese. By changing the stroke volume of the plunger of the high-pressure pump used for injection, the correct salt content can be administered as desired to cheeses having a variable weight or even completely automatically. In the case of the traditional systems with a brine bath or brine flowing the time of contact between the cheese and the brine should be selected such that at the given brine strength and temperature sufficient salt will migrate to the cheese according to the expectation of the man skilled in the art, which afterwards should be confirmed by analysis. It will be clear that the present injection system allows a much better control of the salt content of the cheese. If desired, even saturated brine or a brine suspension can be used.

As has been mentioned, an ordinary brine solution or a solution of dietary salt as is desired can simply be injected. It is also possible to prepare successively low-salt cheese and cheese having a normal salt content and this can be done without interruption of the production process. With a brine flowing system the problems with regard to switching are smaller but also with this system switching is only possible per lot of cheeses which as a group are treated together with the same brine and for the same time. In contrast therewith the present injection of brine allows a process change even per individual cheese.

The present process is a system susceptible to practical applications due to the advantage that the surface of the cheese is only minimally deformed.

The injection system of this invention can also be suitably used for administering other substances then salt to a cheese. Examples thereof are enzymes and micro-organisms, while also aroma substances, flavorings, colorants, proteins and the like can be injected into cheese or imitation cheese, by which a cheese prepared with non-milk fat or non-milk protein is meant.

The advantage of the addition of aroma substances, flavorings colorants, enzymes, micro-organisms and the like with the present system is that no loss of such usually relatively expensive additives is to feared, which loss otherwise does occur. After all, according to the usual practice such a substance is added to the mixture of coagulated curd and whey, so that a substantial part of the additive is lost together with the whey, while the so obtained whey contains the additive and thereby has become unsalable for normal purposes. Thus this type of additives constitutes a large cost factor in the traditional cheese production. Neither is it suitable in the traditional process to add such a substance after the whey has been already separated, because this leads to an irregular distribution of the additive since then only the outside of the panela cheese mass comes into contact with the taste-determining ingredients.

In the production of specialties and new products based on cheese, special effects can be achieved with the present high-pressure injection by using solutions or suspensions of new ingredients. Thus, according to the mention it is for example possible to incorporate vitamins, fibers, lecithin or other substances having a special physiological value into the cheese.

### EXAMPLES OF EMBODIMENTS OF THE INVENTION

The invention will now be described with respect to the following examples, which are solely for the purpose of representing the way of carrying out the implementation of the principles of the invention. The following examples are not intended as a comprehensive representation of the invention, nor try to limit the scope thereof.

### Example 1

A mixture of cheese curds and whey was produced, the mixture was not salted. The cheese curds were passing to the cheeseformer apparatus to form a block of panela cheese, having a lengths of 2.5 cm×10 cm×5 cm, the block of panela cheese was injected with brine directly after leaving the cheeseformer apparatus, using a device designed for injecting meat, poultry and fish with brine without employing needles. The cheese produced to 30° C. was conveyed to the device without any other cooling than caused by the transport. The device contains for its normal use a conveyor belt which transports the material to be treated along the nozzles. In this case the belt was not caused to move. The brine had a concentration of 21%. The injection device was equipped with 48 injection heads containing a nozzle having an opening of 2 mm. The nozzles used were designed such that the brine jet converged at a few mm before the cheese and thereafter became a divergent jet. The brine was injected in an amount of 5% by weight of product per injection using a pressure of about 1 Bar.

For the present experiment, food red color was added to the brine, so that directly after the injection the distribution of the brine throughout the cheese could be checked. It appeared that sufficient divergence of the jets from the nozzles had occurred, so that a homogeneous red color was obtained over the whole surface of the cheese, which coloring homogeneously decreased inwardly. It should be remarked that methylene blue binds to the cheese protein, so that it cannot further diffuse inwardly after the injection. After an otherwise normal post treatment the cheese was stored for ripening and the distribution of the salt content throughout the cheese was analyzed in the young cheese. It was found that the injected salt was distributed uniformly over the whole cheese mass.

Several experiments were carried out with this process. It appeared that when the nozzles were pressed against the cheese, a good distribution of the brine was observed.

### Example 2

Several blocks of panela cheese (identified as S1 to S29) were prepared according to the process described in the Example 1, but the brine had a concentration of 15%, the cheeses were produced at temperature of 21° C., and the brine was injected in an amount 5% by weight of product per injection using a pressure from 0.4 to 2 Bar. The blocks of panela cheese were analyzed without rest or with several minutes of rest after the injection of the brine and after 24 hours of rest, in order to determinate the moisture content and salt content. The results are shown in Table 1.

TABLE 1

| | | Temp. | | | | Temp. | Moisture | Salt |
|---|---|---|---|---|---|---|---|---|
| | | of | | Moisture | Salt | of | content | content |
| | | product | Time of | content | content | product | after 24 | after 24 |
| | Pressure | of the | rest of | of first | of first | after 24 | hours | hours |
| | of | first | the first | analysis | analysis | hours | of rest | of rest |
| Block | injection | analysis | analysis | (% by | (% by | of rest | (% by | (% by |
| ID | (Bar) | (° C.) | (min) | weight) | weight) | (° C.) | weight) | weight) |
| S1 | 0.4 | 35 | 0 | 51.59 | 1.48 | 4 | 54.90 | 1.34 |
| S2 | 0.4 | 35 | 0 | 53.65 | 1.53 | 4 | 52.96 | 1.46 |
| S3 | 0.4 | 35 | 0 | 52.87 | 1.43 | 4 | 55.31 | 1.51 |
| S4 | 0.4 | 35 | 0 | 53.53 | 1.46 | 4 | 54.21 | 1.40 |
| S5 | 0.4 | 35 | 0 | 55.51 | 1.99 | 4 | 55.92 | 2.01 |
| S6 | 0.4 | 35 | 0 | 55.04 | 1.82 | 4 | 55.32 | 1.99 |
| S7 | 0.4 | 35 | 0 | 54.41 | 1.74 | 4 | 55.27 | 1.93 |
| S8 | 0.4 | 35 | 0 | 54.48 | 1.82 | 4 | 55.26 | 1.93 |
| S9 | 0.4 | 35 | 0 | 53.92 | 1.85 | 4 | 55.04 | 1.89 |
| S10 | 0.4 | 35 | 0 | 54.30 | 1.88 | 4 | 54.00 | 1.93 |
| S11 | 0.4 | 35 | 0 | 54.91 | 1.79 | 4 | 55.33 | 2.07 |
| S12 | 0.4 | 35 | 0 | 54.20 | 2.06 | 4 | 55.02 | 2.09 |
| S13 | 1.0 | 40 | 0 | 54.99 | 1.99 | 4 | 56.40 | 2.03 |
| S14 | 1.0 | 40 | 0 | 53.59 | 1.83 | 4 | 55.15 | 1.49 |
| S15 | 1.0 | 40 | 0 | 55.07 | 1.85 | 4 | 56.85 | 1.96 |
| S16 | 1.0 | 40 | 0 | 55.10 | 2.10 | 4 | 57.02 | 2.08 |
| S17 | 0.5 | 36 | 20 | 51.68 | 1.88 | 4 | 53.23 | 2.23 |
| S18 | 0.5 | 36 | 20 | 51.84 | 2.02 | 4 | 53.23 | 1.84 |
| S19 | 0.5 | 36 | 20 | 56.97 | 2.17 | 4 | 54.15 | 2.04 |
| S20 | 0.5 | 36 | 20 | 51.65 | 2.16 | 4 | 53.64 | 1.64 |
| S21 | 0.5 | 36 | 20 | 52.40 | 2.71 | 4 | 53.44 | 2.21 |
| S22 | 0.5 | 36 | 20 | 51.89 | 2.10 | 4 | 53.36 | 1.68 |
| S23 | 0.5 | 36 | 20 | 51.48 | 2.10 | 4 | 53.66 | 2.04 |
| S24 | 0.5 | 36 | 20 | 51.40 | 2.10 | 4 | 53.69 | 2.15 |
| S25 | 2.0 | 40 | 30 | 51.72 | 2.1 | 4 | 53.99 | 2.27 |
| S26 | 1.0 | 40 | 30 | 52.14 | 2.13 | 4 | 53.49 | 2.19 |
| S27 | 1.0 | 40 | 30 | 52.87 | 2.14 | 4 | 53.65 | 1.70 |
| S28 | 0.6 | 42 | 0 | 51.58 | 2.13 | 4 | 53.64 | 2.11 |
| S29 | 0.6 | 42 | 0 | 52.48 | 2.13 | 4 | 54.03 | 2.07 |

There is a variation of content of salt between the “salt content of first analysis” and the “salt content after 24 hours of rest” of the Table 1, because to evaluate the salt content for both cases was needed to take two samples obtained of two different places of the block of panela cheese.

### Example 3

A mixture of cheese curds and whey was produced, the mixture was salted by adding 1.2% by weight of salt. The cheese curds were passing to the cheeseformer apparatus to form a block of panela cheese, having a lengths of 2.5 cm×10 cm×5 cm, the block of panela cheese was injected with brine directly after leaving the cheeseformer apparatus, using a device designed for injecting brine. The cheese produced to 35° C. was conveyed to the device without any other cooling than caused by the transport. The device contains for its normal use a conveyor belt which transports the material to be treated along the nozzles. In this case the belt was not caused to move. The brine had a concentration of 13.8%. The injection device was equipped with 48 injection heads containing a nozzle having an opening of 2 mm. The nozzles used were designed such that the brine jet converged at a few mm before the cheese and thereafter became a divergent jet. The brine was injected in an amount of 5% by weight of product per injection using a pressure of about 1 Bar. The block of panela cheese was analyzed without rest after the injection of the brine, determining a salt content of 1.74% by weight.

Although the present invention has been described by way of particular embodiments and examples thereof, it should be noted that it will be apparent to persons skilled in the art that modifications may be applied to the present particular embodiment without departing from the scope of the present invention.

1. A method for producing panela cheese resulting as by-product whey without salt or with minimal amount of salt, the method comprising the steps of:
(a) processing milk to produce a mixture of cheese curds and whey, wherein optionally the mixture is salted by incorporating a fraction of a total amount of salt required for the manufacture of the panela cheese concerned;
(b) extruding, forming and pressing the cheese curds to form cheese blocks and simultaneously draining the whey from the cheese curds; and
(c) promoting absorption of salt by injecting brine to the cheese blocks, wherein the amount of salt absorbed by the cheese block from the brine represents the complement of the total amount of salt required for the manufacture of the panela cheese concerned.

2. The method of claim 1, wherein the step of (a) processing milk to produce a mixture of cheese curds and whey, the fraction of a total amount of salt is from 0% to 6% by weight.

3. The method of claim 1, wherein between the steps (b) and (c) includes the step of subjecting the obtained cheese blocks to a cooling process or a fast cooling process.

4. The method of claim 1, wherein after the step (c) includes the step of subjecting the obtained cheese blocks to a cooling process or a fast cooling process.

5. A system for producing panela cheese resulting as by-product whey without salt or with minimal amount of salt, the system comprising:
a vat for processing milk to produce a mixture of cheese curds and whey, wherein optionally the mixture is salted by incorporating a fraction of a total amount of salt required for the manufacture of the panela cheese concerned;
a cheeseformer apparatus for extruding, forming and pressing the cheese curds to form cheese blocks and simultaneously draining the whey from the cheese curds; and
a brine injector for promoting absorption of salt by injecting brine to the cheese blocks, wherein the amount of salt absorbed by the cheese block from the brine represents the complement of the total amount of salt required for the manufacture of the panela cheese concerned.

6. The system of claim 5, wherein further includes a cooler for subjecting the obtained cheese blocks to a cooling process or a fast cooling process.
